(19) United States
(12) Patent Application Publication
(10) Pub. No.: US 2019/0392706 A1
(43) Pub. Date: Dec. 26, 2019

(54) Assignment Of A Stoplight To Associated Traffic Lanes

(71) Applicant: Volkswagen Aktiengesellschaft, Wolfsburg (DE)

(72) Inventors: Stephan Max, Gifhorn (DE); Thorben Günzel, Braunschweig (DE); Sven Klomp, Uetze / Dollbergen (DE)

(73) Assignee: Volkswagen Aktiengesellschaft, Wolfsburg (DE)

(21) Appl. No.: 16/447,283

(22) Filed: Jun. 20, 2019

(30) Foreign Application Priority Data
Jun. 21, 2018 (DE) 10 2018 210 125.6

(51) Int. Cl. G08G 1/01; G08G 1/0962; G06K 9/00; G08G 1/16

(52) U.S. Cl. CPC G08G 1/0145; G08G 1/0112; G08G 1/167; G06K 9/00825; G08G 1/09623

(57) ABSTRACT

A method for assigning stoplights of a stoplight system of a traffic lane section controlled by this stoplight system to the traffic lanes of the traffic lane section, wherein the traffic lane section has at least one traffic lane, the traffic lanes of the traffic lane section have a common direction of travel, and a plurality of vehicles are driving on the traffic lane section, comprising the steps:
recognizing an oncoming stoplight system by each vehicle that is driving on the traffic lane section and moving toward the stoplight system,
continuously detecting the stoplight states of the stoplights of the stoplight system, the driven traffic lane, the vehicle speed and the vehicle position by each vehicle, wherein the detection starts at a predetermined distance from the stoplight system then continues until the stoplight system is passed,
transmitting the data recorded by each vehicle on the stoplight states, traffic lane and speed in the form of a data set to a backend computer,
the backend computer performing the following evaluations for each vehicle-specific data set:
determining the recognized stoplight system on a map,
determining the movement of the vehicle through the traffic lane section,
establishing the stoplight states when the vehicle passes the stoplight system, and
creating an assignment table for the recognized stoplight system from the evaluated data sets, wherein the assignment table assigns the stoplights of the stoplight system to the traffic lanes of the traffic lane section.

### CROSS-REFERENCE TO RELATED APPLICATIONS

This application claims priority to German Patent Application No. 10 2018 210 125.6, filed on Jun. 21, 2018 with the German Patent and Trademark Office. The contents of the aforesaid application are incorporated herein for all purposes.

### TECHNICAL FIELD

The invention relates to a method for assigning stoplights to the associated traffic lanes of a road, as well as a use of the method in a vehicle.

### BACKGROUND

In the autonomous, or respectively automated driving of a motor vehicle, the motor vehicle must handle complex stoplight situations at intersections. For this, an automated recognition of the stoplights at an intersection is necessary, wherein this recognition must also comprise an assignment of the stoplights to the respective traffic lanes for which the stoplight signals are responsible. Such an automated recognition of stoplights at intersections is however not just useful for autonomous driving; it can also be used in the supported or semiautomated driving of a motor vehicle in order to support the driver when driving the motor vehicle.

Automated recognition of stoplights at an intersection during automated driving pursues of the following goals:
Recommend to the driver a possible speed toward the stoplight system,
automatically stop in front of the stoplight,
warn the driver in the event of unintentionally running the stoplight, and
give the driver instructions to continue driving when the stoplight turns green again.

To implement these examples, an attempt is made to monitor the stoplights with the front camera in the vehicle. In doing so, the following measuring tasks must be mastered:
The camera recognizes the stoplight in the forefield and measures it with respect to position and orientation.
The camera recognizes the lanes and markers on the ground and thus establishes an assignment of the stoplight to the lanes.
The camera continuously monitors the state of the relevant stoplight and passes on this information to the corresponding function.

However in reality, the assignment of stoplights to traffic lanes is very difficult to determine because of the varied and complex intersection situations, which leads to high error rates in the assignment of stoplights to traffic lanes.

The document DE 10 2014 205 953 A1 relates to a method for analyzing a traffic environment situation of a vehicle with a navigation system and a sensor system, wherein the navigation system determines a vehicle position, and the sensor system determines vehicle movement data as well as ascertains vehicle movement behavior in the form of vehicle movement trajectories, wherein the vehicle position enable and the vehicle movement trajectories enable an inference about the presence and/or the type of at least one feature of the environment, wherein a sensor of the sensor system detects the feature and saves at least one additional information about the feature.

The document DE 10 2013 220 662 A1 describes a method for recognizing traffic situations when operating a vehicle on a road having several traffic lanes, comprising the following features:
with the assistance of a vehicle-side sensor system, various environmental data relating to a signal system status, a road boundary, a traffic lane boundary, and at least one additional marker on the road, are optically detected, and
by using the environmental data detected by means of the sensor system, a relation is established between the vehicle status that at least comprises the disclosure of the traffic lane used by the vehicle, and the signal system status valid for this vehicle status.

The subsequently published document DE 10 2018 004 667 A1 relates to method for determining an associated driving direction of a traffic light system, wherein the traffic light system is detected by means of a camera system attached to a vehicle, and the detected information is sent to an external computer unit and evaluated thereby. It is provided that the information of the detected traffic light system detected by the camera system is correlated with the information saved in the external computer unit, and the associated travel direction is determined by using the correlation.

The document DE 10 2016 217 558 A1 relates to a method for assigning a stoplight to a traffic lane, wherein recognized phase sequences are compared with expected phase sequences. Moreover, the document relates to an associated vehicle and an associated storage medium.

### SUMMARY

The underlying object of the invention is to create a method for assigning stoplights to traffic lanes, and use of the method with an improved assignment of the stoplights to the traffic lanes.

This object is achieved by a method having the features the independent claims. Embodiments are described in the dependent claims and the following description.

In one aspect, a method for assigning stoplights of a stoplight system of a traffic lane section controlled by this stoplight system to the traffic lanes of the traffic lane section is provided. The traffic lane section has at least one traffic lane, the traffic lanes of the traffic lane section have a common direction of travel, and a plurality of vehicles are driving on the traffic lane section. The method comprises the steps:
recognizing an oncoming stoplight system by each vehicle that is driving on the traffic lane section and moving toward the stoplight system,
continuously detecting the stoplight states of the stoplights of the stoplight system, the driven traffic lane, the vehicle speed and the vehicle position by each vehicle, wherein the detection starts at a predetermined distance from the stoplight system then continues until the stoplight system is passed,
transmitting the data recorded by each vehicle on the stoplight states, traffic lane and speed in the form of a data set to a backend computer,
the backend computer performing the following evaluations for each vehicle-specific data set:
determining the recognized stoplight system on a map,
determining the movement of the vehicle through the traffic lane section,
establishing the stoplight states when the vehicle passes the stoplight system, and
creating an assignment table for the recognized stoplight system from the evaluated data sets, wherein the assignment table assigns the stoplights of the stoplight system to the traffic lanes of the traffic lane section.

### DESCRIPTION OF THE DRAWINGS

IN THE FIGS.:

FIG. 1 an intersection situation with corresponding stoplight systems, and

FIG. 2 a detailed representation of a stoplight system for three traffic lanes at an intersection.

### DETAILED DESCRIPTION

Technical features described in this application can be used to construct various embodiments of battery housings and electric vehicles. Some embodiments of the invention are discussed so as to enable one skilled in the art to make and use the invention.

In one aspect, a method for assigning stoplights of a stoplight system of a traffic lane section controlled by this stoplight system of an intersection to the traffic lanes of the traffic lane section, wherein the traffic lane section has at least one traffic lane, the traffic lanes of the traffic lane section have a common direction of travel, and a plurality of vehicles forming a cluster are driving on the traffic lane section, having the steps:
Recognizing an oncoming stoplight system by each vehicle of the cluster that is driving on the traffic lane section and moving toward the stoplight system,
continuously detecting the stoplight states of the stoplights of the stoplight system, the driven traffic lane, the vehicle speed and the vehicle position by each vehicle, wherein the detection starts at a predetermined distance from the stoplight system then continues until the stoplight system is passed,
transmitting the data recorded by each vehicle on the stoplight states, driven traffic lane and vehicle speed in the form of a data set to a backend computer, and
the backend computer performs the following evaluations for each vehicle-specific data set:
determining the recognized stoplight system on a map,
determining the movement of the vehicle through the traffic lane section,
establishing the stoplight states when the vehicle passes the stoplight system,

and
creating a vehicle-retrievable assignment table in the backend computer in the form of a matrix for the recognized stoplight system from the evaluated data sets of the vehicle cluster, wherein the assignment table assigns the stoplights of the stoplight system to the traffic lanes of the traffic lane section, wherein
in the assignment table, the stoplights of the stoplight system are listed with the stoplight states, wherein the stoplight states are limited to red and green, and
the traffic lanes of the traffic lane section are listed in the assignment table, wherein the traffic lanes have the binary values for crossing and for stopping as a function of the stoplight states.

The method according to the present aspect therefore determines a traffic lane assignment of the stoplights by using cluster data from a plurality of test vehicles. In doing so, the behavior of the drivers and the monitorings of the stoplight states are compared in order to determine a correct assignment of the stoplights to the traffic lanes for each traffic lane section, in particular an intersection.

In some embodiments, the predetermined distance may be 500 m as of which the detection of the stoplight states of the stoplight system is started, wherein the predetermined distance may be less depending on the application, for example when a plurality of intersections are arranged in a quick sequence one after the other.

In some embodiments, the assignment table per stoplight system may be saved in a database, whereby the assignment table is retrievable for the vehicles.

In the assignment table, the stoplights of the stoplight system may be listed with the stoplight states, wherein the stoplight states are limited to red and green. By means of this exemplary limitation to the two relevant stoplight states that indicate whether passing or stopping at the stop light is required, the stoplight states can be expressed in the assignment table by a bit.

Furthermore, the traffic lanes may be listed in the assignment table, wherein the traffic lanes have the binary values for crossing and for stopping as a function of the stoplight states.

In some embodiments, the vehicles driving on the traffic lane section may be manually controlled to create the data sets. The “cluster” of test vehicles for determining the assignment tables may be controlled manually so that the assignment of stoplights to traffic lanes may be retrieved for later autonomous driving for important intersections so that autonomous driving may be reliably configured.

In another aspect, the method according to the preceding aspect for assigning stoplights of a stoplight system of a traffic lane section controlled by this stoplight system to the traffic lanes of the traffic lane section is used in a vehicle driving on the traffic lane section. In some embodiments, the vehicle determines the position of the controlling stoplight system for the traffic lane section and requests the assignment table of the relevant stoplight system from a database based on this position. In some embodiments, the vehicle may use the assignment table to support the driver in an assistance system.

In some embodiments, the requested assignment table is evaluated in the vehicle together with current vehicle data, wherein the current vehicle data in particular relate to the current lane deviation, turn signal settings and/or navigation routes.

Reference will now be made to the drawings in which the various elements of embodiments will be given numerical designations and in which further embodiments will be discussed.

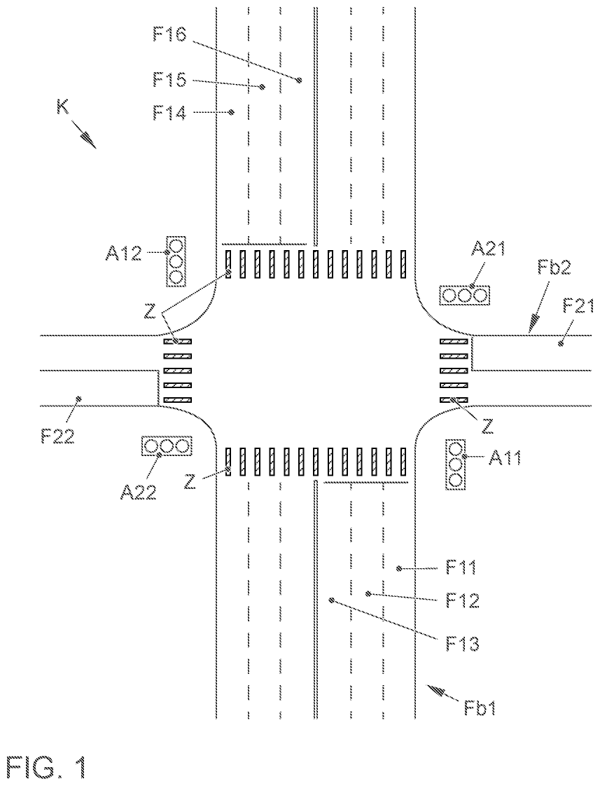

A typical intersection situation is described in FIG. 1 that will be used to explain the method. An intersection K is formed by the meeting of the two traffic lanes Fb1 and Fb2. In this case, the first traffic lane Fb1 comprises a total of six traffic lanes F11 to F16, wherein three traffic lanes

run upward, and the other three traffic lanes F14 to F16 have the opposite direction, shown in FIG. 1. The second traffic lane Fb2 running perpendicular to the first traffic lane Fb1 comprises two traffic lanes F21 and F22 which run in the opposite direction. The traffic situation of the intersection K with the two traffic lanes Fb1 and Fb2 is regulated by four stoplight systems A11, A12, A21 and A22 that are connected to each other, wherein the stoplight system A11 is responsible for the traffic lanes F11 to F13, the stoplight system A12 is responsible for the traffic lanes F14 to F16, the stoplight system A21 is responsible for the traffic lane F21, and the stoplight system A22 is responsible for the traffic lane F22. Furthermore, pedestrian crossings in the form of zebra crossings Z are drawn in FIG. 1 for the sake of completeness.

The stoplight systems A11, A12, A21 and A22 that are only symbolically drawn in FIG. 1 may comprise several stoplights with special meanings depending on the type of intersection, and for example may be a function of the number of traffic lanes. Accordingly, the stoplight systems A11 and A12 of the traffic lane Fb1 with its three traffic lanes per direction, F11 to F16, regulates in each direction the driving behavior of driving straight, turning to the left and turning to the right so that these stoplight systems A11 and A12 normally consist of several stoplight that are responsible for the respective driving behavior. In other words, the aforementioned stoplight systems A11 and A12 comprise separate stoplights for driving straight, for turning left and for turning right.

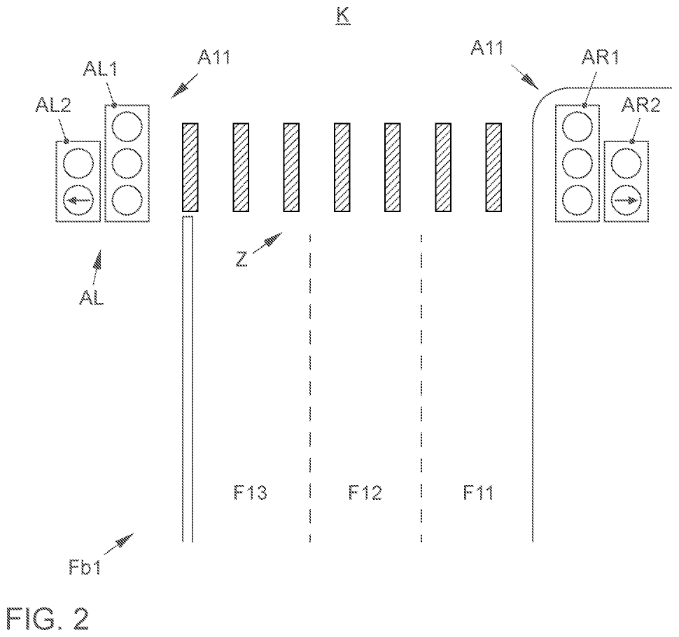

This is depicted in FIG. 2 which shows the traffic situation at the intersection K in detail with respect to the stoplight system A11 with the zebra crossings Z and the controlled traffic lanes F11, F12 and F13. The right partial stoplight system AR and the left partial stoplight system AL of the stoplight system A11 serve to control the traffic on the aforementioned traffic lanes F11, F12 and F13. In doing so, the right partial stoplight system AR regulates both the through traffic of the three traffic lanes F11, F12 and F13 by means of stoplight AR1 as well as the right turning traffic on the right traffic lane F11 by means of the stoplight AR2. Moreover, the left partial stoplight system AL also regulates the through traffic on the three traffic lanes F11, F12 and F13 by means of stoplight AL1 as well as the left turning traffic on the left traffic lane F13 by means of the stoplight AL2.

The method comprises the following steps:
a) In the forefield, the vehicle recognizes a stoplight system as well as the status of individual stoplights, i.e., green, yellow, red, red/yellow, and recognizes the lane on which it is moving. This data is recorded continuously until the vehicle has passed the stop light. In addition, the speed is also recorded in order to determine whether the vehicle has stopped before the stoplight or could cross without stopping. In real environments, it is furthermore possible for the stoplight state to not be correctly recognized. This can result from poor visibility conditions (glare, dirt, etc.) from coverage of the stoplight (for example a truck in the line of sight), or stop lights outside of the field of vision, or respectively opening angle of the camera. In these cases, only the recognized stoplight states are reported—missing states are unknown to the vehicle and therefore cannot be communicated.
b) The recorded data are sent to a backend system.
c) The following is carried out in the backend:
   i) the recognized stoplight system is referenced on a map
   ii) the movement of the vehicle through the intersection is recognized
   iii) the stoplight is established when crossing the intersection

For the stoplight system A11 depicted in FIG. 2, examples of data sets are indicated in the following table as they are sent to the backend computer, or respectively are in the backend computer for processing:

TABLE 1

| | Stoplight | | | |
|---|---|---|---|---|
| Right turn | without | Left turn | | |
| stoplight | arrow AR1 | stoplight | Driven | Crossed |
| AR2 | and AR2 | AL2 | lane | (1)/stopped (0) |
| Red | Red | Green | F13 | 1 |
| Red | 0 | Green | F12 | 0 |
| Red | Green | Red | F11 | 1 |
| Red | Green | Red | F12 | 1 |
| Red | Green | Red | F13 | 1 |

The following holds true for the driving behavior at the stoplight:
crossed=“1”, stopped=“0”.

The above data sets transmitted to the backend computer therefore contain the information on the stoplight states, the traffic lane occupied by the vehicle and the behavior at the intersection, i.e., whether the vehicle is stopping or crossing. For example, the first line means that a vehicle in the left lane F13 has crossed, wherein the stoplight AL2 was “green” for turning left while all other stoplights showed “red”. From this it can be concluded that the stoplight AL2 is associated with the left traffic lane F13.
e) If it is assumed that the intersection is only crossed in the event of green, an assignment to a possible traffic lane can be made. From the above example, it can be seen that driving on lane 3 can occur when the left stoplight AL2 is green, but not on lane 2. Information on lane 1 is still pending. Moreover, all traffic lanes can be driven on if the stoplight without the arrow AR1, AL1 is green.
f) Depending on the stoplight system, the stoplight display is ambiguous. For example, both through traffic as well as turning left are green in the stoplight system. However, the vehicle chooses only the left exit. This however does not cause functional impairments—since this is solved by an assignment table—that must be detected by each stoplight system. Detection occurs over several crossings that are recorded by the “vehicle cluster”. In doing so, each vehicle determines the state in the form of a Boolean variable with the values “0” or “1” for the lane for the corresponding state of the stoplight system.

Potential stoplights that are not recognized by the vehicles and are therefore not reported are in this case not included in the expansion of the table and contribute nothing to the accumulation of information, and nothing to the error states as well, and can consequently be tolerated.

From the data of the “cluster fleet” transmitted to the backend which are shown in table 1, an assignment table is setup in the form of a matrix for the intersection section relating to stoplight the system A11 and for example are reproduced in table 2. The assignment tables for the other intersection sections depicted in FIG. 1 relating to stoplight systems A12, A21 and A22 look the same.

TABLE 2

| | Stoplights | | | | |
|---|---|---|---|---|---|
| Right | without | Left | | | |
| stoplight | arrow AR1, | stoplight | Traffic | Traffic | Traffic |
| AR2 (1 = | AL1 (1 = | AL2 (1 = | lane F11 | lane F12 | lane F13 |
| green, | green, | green, | (0 = drive, | (0 = drive, | (0 = drive, |
| 0 = red) | 0 = red) | 0 = red) | 1 = stop) | 1 = stop) | 1 = stop) |
| 0 | 0 | 1 | 0 | 0 | 1 |
| 0 | 1 | 0 | 1 | 1 | 1 |
| 0 | 1 | 1 | 1 | 1 | 1 |
| 1 | 0 | 0 | 1 | 0 | 0 |
| 1 | 0 | 1 | 1 | 0 | 1 |
| 1 | 1 | 0 | 1 | 1 | 1 |
| 1 | 1 | 1 | 1 | 1 | 1 |

g) Once this assignment is determined, it is saved in the database in the form of an assignment table per stoplight system and transmitted to the vehicles, for example as a layer in the map.
h) If the automobile again approaches the stoplight system, the possible free lanes can be determined using the assignment table.
i) This situation is then evaluated together with the current lane deviation, turn signal settings, navigation routes, etc. by the functions.

A further improvement may be achieved in some embodiments if the entry in the table may be directly determined in the vehicle. In this case, expanded logic in the vehicle may be required—however, the data volume may be significantly reduced in this manner, since only the state of the path in relation to the stoplight state must be transmitted in this case.

### REFERENCE NUMBER LIST

K intersection
Fb1 traffic lane 1 of traffic lane 1
Fb2 traffic lane 2 of traffic lane 1
F11 traffic lane 1 of traffic lane 1
F12 traffic lane 2 of traffic lane 1
F13 traffic lane 3 of traffic lane 1
F14 traffic lane 4 of traffic lane 1
F15 traffic lane 5 of traffic lane 1
F16 traffic lane 6 of traffic lane 1
F21 traffic lane 1 of traffic lane 2
F22 traffic lane 2 of traffic lane 2
A11 stoplight system for traffic lanes F11 to F13
A12 stoplight system for traffic lanes F14 to F16
A21 stoplight system for traffic lane F21
A22 stoplight system for traffic lane F22
Z zebra crossings
AR right partial stoplight system
AR1 through-traffic stoplight
AR2 right turn stoplight
AL left partial stoplight system
AL1 through-traffic stoplight
AL2 left turn stoplight

The invention has been described in the preceding using various exemplary embodiments. Other variations to the disclosed embodiments can be understood and effected by those skilled in the art in practicing the claimed invention, from a study of the drawings, the disclosure, and the appended claims. In the claims, the words “comprising” and “including” does not exclude other elements or steps, and the indefinite article “a” or “an” does not exclude a plurality. A single processor, module or other unit or device may fulfil the functions of several items recited in the claims.

The mere fact that certain measures are recited in mutually different dependent claims or embodiments does not indicate that a combination of these measured cannot be used to advantage. Any reference signs in the claims should not be construed as limiting the scope.

What is claimed is:

1. A method for assigning stoplights of a stoplight system of a traffic lane section controlled by this stoplight system of an intersection to the traffic lanes of the traffic lane section, wherein the traffic lane section has a least one traffic lane, the traffic lanes of the traffic lane section have a common direction of travel, and a plurality of vehicles forming a cluster drive on the traffic lane section, having the steps:
recognizing an oncoming stoplight system by each vehicle of the cluster that is driving on the traffic lane section and moving toward the stoplight system;
continuously detecting the stoplight states of the stoplights of the stoplight system, the driven traffic lane, the vehicle speed and the vehicle position by each vehicle, wherein the detection starts at a predetermined distance from the stoplight system and continues until the stoplight system is passed;
transmitting the data recorded by each vehicle on the stoplight states, driven traffic lane and vehicle speed in the form of a data set to a backend computer;
performing the following evaluations by the backend computer for each vehicle-specific data set of the vehicles of the cluster:
determining the recognized stoplight system on a map;
determining the movement of the vehicle through the traffic lane section;
establishing the stoplight states when the vehicle passes the stoplight system;
and
creating a vehicle-retrievable assignment table in the backend computer in the form of a matrix for the recognized stoplight system from the evaluated data sets of the vehicle cluster, wherein the assignment table assigns the stoplights of the stoplight system to the traffic lanes of the traffic lane section, wherein
in the assignment table, the stoplights of the stoplight system are listed with the stoplight states, wherein the stoplight states are limited to red and green, and
the traffic lanes of the traffic lane section are listed in the assignment table, wherein the traffic lanes have binary values for crossing and for stopping as a function of the stoplight states.

2. The method according to claim 1, wherein the predetermined distance is 500 m or less.

3. The method according to claim 1, wherein the assignment table per stoplight system is saved in a database.

4. The method according to claim 1, wherein the vehicles driving on the traffic lane section are manually controlled to create the data sets.

5. A use of a method for assigning stoplights of a stoplight system of a traffic lane section controlled by this stoplight system to the traffic lanes of the traffic lane section according to claim 1 in a vehicle driving on the traffic lane section, wherein the vehicle determines the position of the controlling stoplight system for the traffic lane section and requests the assignment table of the relevant stoplight system from a database based on this position, and uses it to support the driver in an assistance system.

6. The use of the method according to claim 5, wherein the requested assignment table in the vehicle is evaluated together with current vehicle data.

7. The use of the method according to claim 6, wherein the current vehicle data relate to the current lane deviation, turn signal settings and/or navigation routes.

8. The method according to claim 2, wherein the assignment table per stoplight system is saved in a database.

9. The method according to claim 2, wherein the vehicles driving on the traffic lane section are manually controlled to create the data sets.

10. The method according to claim 3, wherein the vehicles driving on the traffic lane section are manually controlled to create the data sets.

11. A vehicle with a system for executing the method for assigning stoplights of a stoplight system of a traffic lane section controlled by this stoplight system to the traffic lanes of the traffic lane section according to claim 1, wherein the vehicle determines the position of the controlling stoplight system for the traffic lane section and requests the assignment table of the relevant stoplight system from a database based on this position, and employs the database to support the driver in an assistance system.

12. The vehicle of claim 11, wherein the requested assignment table in the vehicle is evaluated together with current vehicle data.

13. The vehicle of claim 12, wherein the current vehicle data relate to the current lane deviation, turn signal settings and/or navigation routes.
